(19) United States
(12) Patent Application Publication
(10) Pub. No.: US 2005/0219777 A1
(43) Pub. Date: Oct. 6, 2005

(54) Wire bonding apparatus

(75) Inventor: Kazumasa Sasakura, Higashiyamato (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/093,712

(22) Filed: Mar. 30, 2005

(30) Foreign Application Priority Data
Mar. 30, 2004 (JP) 2004-097401

(51) Int. Cl. H02H 3/00

(52) U.S. Cl. 361/42

(57) ABSTRACT

A wire bonding apparatus wherein in a high-voltage power supply, an electric torch is connected to the high-voltage side and a wire is connected to the ground side via a ground line, a high voltage is applied across the wire and the electric torch by the high-voltage power supply, thus causing electrical discharge to form a ball on the tip end of the wire, and in a constant-current circuit a current detection circuit, which detects the discharge current, and a high-voltage control circuit, which controls the high voltage in accordance with the discharge current, are provided; and the current detection circuit detects the current that flows through the ground line and is connected to input the detected current into the high-voltage control circuit, and it is judged that the ground line is broken when there is no output from the current detection circuit during the discharge.

### BACKGROUND OF THE INVENTION

1. Technical Field

The present invention relates to a wire bonding apparatus and more particularly to a system for forming a ball on the tip end of a bonding wire in a wire bonding apparatus.

2. Description of the Related Art

In a wire bonding apparatus, as shown in FIG. 2, one end of a wire 1 wound on a spool (not shown in the drawings) is passed through a capillary 3 via a damper 2. The other end of the wire 1 is connected by a ground line 5 to the ground side terminal of a high-voltage power supply 4. An electric torch 6 which is used to form a ball on the tip end of the wire 1 is connected by a voltage feed line 7 to a constant-current circuit 10 (described later), and this constant-current circuit 10 is connected to the high-voltage side of the high-voltage power supply 4.

The constant-current circuit 10 has a high-voltage control circuit 11 and a current detection circuit 12. The high-voltage side of the high-voltage power supply 4 is connected to the plus (or positive) side input terminal (+) of the high-voltage control circuit 11, and the output terminal of the current detection circuit 12 is connected to the minus (negative) side input terminal (−) of the high-voltage control circuit 11. The output end of the high-voltage control circuit 11 is connected to the high-voltage feed line 7 via a resistor 13. The electric current that flows through the resistor 13 is detected by the current detection circuit 12.

The above-described system is disclosed in, for example, Japanese Patent Application Laid-Open (Kokai) Nos. H2-298874 (Japanese Patent No. 2617351) and 2000-208550.

The operation of the system shown in FIG. 2 will be described below.

The high voltage that is outputted from the high-voltage power supply 4 during ball formation is applied across the electric torch 6 and tip end of the wire 1 via the high-voltage control circuit 11 so that a discharge (electrical discharge) takes place, thus causing an electric current (or just called “current”) to flow. This current is detected as the detected voltage E1 across both ends of the resistor 13, and the difference between this detected voltage E1 and a control voltage E2 from the current detection circuit 12 is amplified by the high-voltage control circuit 11, so that the current that flows through the wire 1 is controlled. In the high-voltage control circuit 11, control is performed so that the voltages of the plus side input terminal (+) and minus side input terminal (−) are substantially equal. In other words, the output current that flows across the wire 1 and electric torch 6 is controlled to a constant current by the control voltage E2.

In cases where there is a break 5a in the ground line 5, the current that flows from the high-voltage side of the high-voltage power supply 4 to the ground side of the high-voltage power supply 4 via the voltage feed line 7, electric torch 6, wire 1 and ground line 5 is cut off; accordingly, there is no discharge to the wire 1, and thus there is no formation of a ball. However, the high-voltage power supply 4 has a high discharge voltage of (e.g.) −3000 V so that a current may flow to ground via the insulation of the wire guide (not shown in the drawings) that guides the wire 1. When the discharge ends, since the ground line 5 is broken at 5a, the path through which this current flows is eliminated, and as a result the charge from the time of the discharge remains in the wire and wire path. This causes a problem. In other words, there is a danger that the remaining charge will be discharged to a semiconductor element when the bonding is performed to a first bonding point on the semiconductor element in the next process, thus damaging the semiconductor element.

A wire breakage detection means for detecting the breakage 5a of the ground line 5 might be provided in order to solve such a problem. In cases where the voltage feed line 7 breaks, the there is no discharge from the electric torch 6 to the wire 1, and such a problem as described above does not arise.

### BRIEF SUMMARY OF THE INVENTION

The object of the present invention is to provide a wire bonding apparatus that detects breakage of the ground line without any need to install special wire breakage detection means that detects breakage of the ground line, thus avoiding increase in the cost of bonding apparatuses.

The above object is accomplished by a unique structure of the present invention for a wire bonding apparatus that includes a high-voltage power supply and a constant-current circuit, wherein
the high-voltage side of the high-voltage power supply is connected to an electric torch via a voltage supply line,
a wire is connected to the ground side of the high-voltage power supply via a ground line, and
a high voltage is applied across the tip end of the wire and the electric torch by means of the high-voltage power supply, so that an electrical discharge is caused to take place, thus forming a ball on the tip end of the wire; and
the constant-current circuit, which controls the discharge current so that the discharge current is maintained at a constant value, includes a current detection circuit, which detects the discharge current, and a high-voltage control circuit, which controls the high voltage in accordance with the discharge current; and in the present invention,
the current detection circuit of the constant-current circuit detects the current that flows through the ground line and is connected so that the detected current is inputted into the high-voltage control circuit of the constant-current circuit, and
it is judged that the ground line is broken in cases where there is no output from the current detection circuit during the discharge.

In the above structure,
the output terminal of the high-voltage control circuit is connected to the electric torch, the high-voltage side of the high-voltage power supply is connected to the plus side input terminal of the high-voltage control circuit, and the output terminal of the current detection circuit is connected to the minus side input terminal of the high-voltage control circuit; and
the input terminal of the current detection circuit is provided so that the current that flows through the ground line is detected.

The above-described wire bonding apparatus may further includes a ground line continuity detection means. This ground line continuity detection means is actuated so as to detect electrical continuity of the ground line when it is judged that the ground line is broken in cases where there is no output from the current detection circuit during the discharge; and depending on the electrical continuity detected by the ground line continuity detection means, it is judged that the ground line is broken or that there has been a faulty discharge.

In the present invention, since the current detection circuit of the constant-current circuit is connected so that the current that flows from the ground line to the high-voltage power supply is detected, breakage of the ground line is detected when there is no output from the current detection circuit. In other words, since there is no need to install any special wire breakage detection means for the purpose of detecting breakage of the ground line, there is no increase in the cost of the apparatus. In addition, in the present invention, a ground line continuity detection means that automatically ascertains whether there has been a breakage of the ground line or a faulty discharge is provided. Accordingly, it can be judged by the ground line continuity detection means whether there has been a breakage of the ground line or a faulty discharge in cases where there is no output from the current detection circuit, so that the worker can immediately take countermeasures.

### BRIEF DESCRIPTION OF THE SEVERAL VIEWS OF THE DRAWINGS

FIG. 1 is a structural diagram of the essential parts of one embodiment of the wire bonding apparatus according to the present invention; and

FIG. 2 is a structural diagram of essential parts of a conventional wire bonding apparatus.

### DETAILED DESCRIPTION OF THE INVENTION

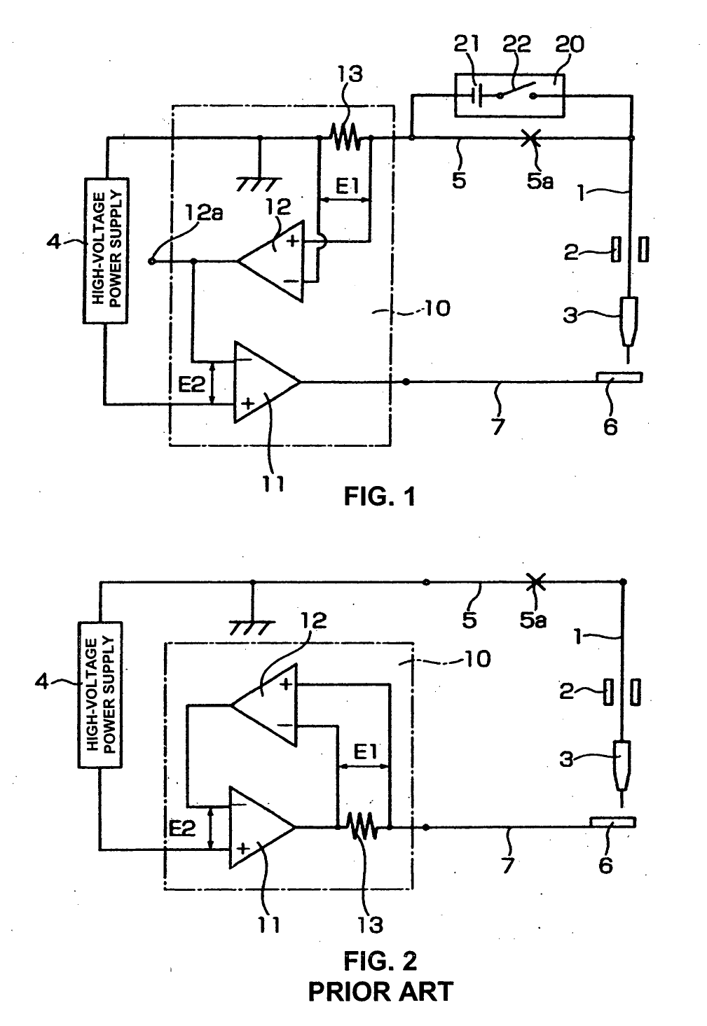

One embodiment of the present invention will be described with reference to FIG. 1. Constituting elements that are the same as members in FIG. 2 or that correspond to the elements in FIG. 2 are labeled with the same symbols, and a detailed description of such members will be omitted.

In the embodiment of the present invention, the connections of the high-voltage control circuit 11 of the constant-current circuit 10 are the same as in a conventional apparatus; however, the connections of the current detection circuit 12 of the constant-current circuit 10 differ from those in a conventional apparatus. More specifically, the current detection circuit 12 detects the current that flows to the ground side of the high-voltage power supply 4 via the ground line 5. A resistor 13 is connected to the terminal of the ground line 5 on the side of the high-voltage power supply 4 so that grounding is effected, and the current that flows through this resistor 13 is detected by the current detection circuit 12.

Next, the operation of the above system shown in FIG. 1 will be described.

In cases where there is no break 5a in the ground line 5, a ball is formed on the tip end of the wire 1 by substantially the same action as in the conventional apparatus of FIG. 2. In other words, the high voltage that is outputted from the high-voltage power supply 4 during ball formation is applied across the electric torch 6 and tip end of the wire 1 via the high-voltage control circuit 11, so that a discharge (electrical discharge) takes place, and a current is caused to flow. This current is detected as the detected voltage E1 across both ends of the resistor 13, and the difference between this detected voltage E1 and a control voltage E2 from the current detection circuit 12 is amplified by the high-voltage control circuit 11, so that the current that flows through the wire 1 is controlled. In the high-voltage control circuit 11, control is performed so that the voltages of the plus side input terminal (+) and minus side input terminal (−) are substantially equal. More specifically, the output current that flows across the wire 1 and electric torch 6 is controlled to a constant current by the control voltage E2.

In cases where there is a break 5a in the ground line 5, the current that flows from the high-voltage side of the high-voltage power supply 4 to the ground side of the high-voltage power supply 4 via the voltage feed line 7, electric torch 6, wire 1 and ground line 5 is cut off; accordingly, there is no electrical discharge to the wire 1. In other words, since no current flows through the ground line 5, there is no output from the current detection circuit 12. Accordingly, in cases where there is no output from the output terminal 12a of the current detection circuit 12, a computer (not shown in the drawings) judges that a break has occurred (at, for instance, 5a) in the ground line 5. A signal, which indicates that there is a break (5a) in the ground line 5 and which stops the bonding apparatus, is outputted. As a result, the discharge of the charge on the wire 1 onto a semiconductor element is prevented, and no damage occurs to the semiconductor element.

Thus, since the current detection circuit 12 of the constant-current circuit 10 is connected so that the current that flows to the high-voltage power supply 4 from the ground line 5 is detected, detection of any break (5a) in the ground line 5 is assuredly made. In other word, since there is no need to install any special wire breakage detection means for detecting a break in the ground line 5, there is no increase in the cost of the bonding apparatus.

There could be instances in which a faulty discharge involving a discharge from the electric torch 6 onto the semiconductor element occurs, though the probability of such an erroneous discharge occurring is small. In such instances, since no current flows to the wire 1, in the shown embodiment, it is judged that a break (5a) has occurred in the ground line 5 as described above, and the system stops. As a result, the worker can check for a break in the ground line 5; and in cases where there is no break in the ground line 5, the worker judges that there has been a faulty discharge.

In the shown embodiment, a ground line continuity detection means 20 that automatically ascertains whether there has been a break 5a in the ground line 5 or a faulty discharge is provided so that it is connected to both ends of the ground line 5. Such a ground line continuity detection means 20 is comprised of a direct-current power supply 21 and a switch 22. In cases where there is no output from the output end 12a of the current detection circuit 12 as described above, the switch 22 is switched on by a command from the computer, and the electrical continuity of the ground line 5 is detected. In cases where the ground line 5 shows electrical continuity, it is judged that a faulty discharge has occurred, and an indication of this is displayed. As a result, it can be judged whether a break in the ground line 5 or a faulty discharge has occurred, and the worker can take immediate countermeasures.

1. A wire bonding apparatus comprising a high-voltage power supply and a constant-current circuit, wherein
a high-voltage side of said high-voltage power supply is connected to an electric torch via a voltage supply line,
a wire is connected to a ground side of said high-voltage power supply via a ground line, and
a high voltage is applied across a tip end of said wire and said electric torch by means of said high-voltage power supply, so that a discharge is caused to take place, thus forming a ball on a tip end of said wire; and
said constant-current circuit, which controls a discharge current so that said discharge current is maintained at a constant value, includes
a current detection circuit that detects said discharge current, and
a high-voltage control circuit that controls said high voltage in accordance with said discharge current; and wherein
said current detection circuit of said constant-current circuit detects a current that flows through said ground line and is connected so that said detected current is inputted into said high-voltage control circuit of said constant-current circuit, and
it is judged that said ground line is broken in cases where there is no output from said current detection circuit during said discharge.

2. The wire bonding apparatus according to claim 1, wherein
an output terminal of said high-voltage control circuit is connected to said electric torch, a high-voltage side of said high-voltage power supply is connected to a plus side input terminal of the high-voltage control circuit, and an output terminal of said current detection circuit is connected to a minus side input terminal of said high-voltage control circuit; and
an input terminal of said current detection circuit is provided so that a current that flows through said ground line is detected.

3. A wire bonding apparatus comprising a high-voltage power supply and a constant-current circuit, wherein
a high-voltage side of said high-voltage power supply is connected to an electric torch via a voltage supply line,
a wire is connected to a ground side of said high-voltage power supply via a ground line, and
a high voltage is applied across a tip end of said wire and said electric torch by means of said high-voltage power supply, so that a discharge is caused to take place, thus forming a ball on a tip end of said wire; and
said constant-current circuit, which controls a discharge current so that said discharge current is maintained at a constant value, includes:
a current detection circuit that detects said discharge current, and
a high-voltage control circuit that controls said high voltage in accordance with said discharge current; and wherein
said current detection circuit of said constant-current circuit detects a current that flows through said ground line and is connected so that said detected current is inputted into said high-voltage control circuit of said constant-current circuit,
a ground line continuity detection means is provided which is actuated so as to detect electrical continuity of said ground line when it is judged that said ground line is broken in cases where there is no output from said current detection circuit during said discharge, and
depending on an electrical continuity detected by said ground line continuity detection means, it is judged that said ground line is broken or that there has been a faulty discharge.

4. The wire bonding apparatus according to claim 3, wherein
an output terminal of said high-voltage control circuit is connected to said electric torch, a high-voltage side of said high-voltage power supply is connected to a plus side input terminal of the high-voltage control circuit, and an output terminal of said current detection circuit is connected to a minus side input terminal of said high-voltage control circuit; and
an input terminal of said current detection circuit is provided so that a current that flows through said ground line is detected.
